(19) United States
(12) Patent Application Publication
(10) Pub. No.: US 2022/0349855 A1
(43) Pub. Date: Nov. 3, 2022

(54) GLOVE SCANNER

(71) Applicant: Olympus NDT Canada Inc., Québec (CA)

(72) Inventors: Olivier Royer, Québec (CA); Luis Cooper, Quebec (CA); Terence Burke, Québec (CA)

(21) Appl. No.: 17/660,438

(22) Filed: Apr. 25, 2022

Related U.S. Application Data
(60) Provisional application No. 63/180,812, filed on Apr. 28, 2021.

(51) Int. Cl. G01N 27/9013; G01N 27/90; A41D 19/00

(52) U.S. Cl. CPC G01N 27/902; G01N 27/9006; A41D 19/0027

(57) ABSTRACT

A wearable inspection device for inspecting an article is provided. The wearable inspection device includes a wearable portion and an eddy current probe at the wearable portion. The eddy current probe is configured to interface with the article and inspect the article. The wearable inspection device also includes an operator interface coupled with the eddy current probe. The eddy current probe can transmit data to the operator interface such that the operator interface can display data to a user. The operator interface also defines a probe status indicator configured to indicate a status of the at least one probe with respect to the article.

### CROSS-REFERENCE TO RELATED APPLICATION

This application claims the benefit of priority to U.S. Provisional Patent Application Ser. No. 63/180,812 filed Apr. 28, 2021, the contents of which are incorporated herein by reference in their entirety.

### TECHNICAL FIELD

This document pertains generally, but not by way of limitation, to an article inspection system. More specifically, but not by way of limitation, the present application relates to a wearable device that can be used to inspect an article.

### BACKGROUND

Eddy current testing (ECT) is used for non-destructive testing of conductive materials. For example, components that are used for aerospace applications, such as fuselages and airplane wings, along with components in the petrochemical industry, such as metal piping and other alloy tubing, can be inspected using ECT to detect flaws such as cracks, corrosion, or defects that may otherwise be invisible or inaccessible using visual inspection. As illustrative examples, ECT can be used to detect cracks in metal sheets or tubing or identifying corrosion on or below a conductive surface being inspected. Furthermore, ECT may be used to monitor the effects of heat treatment on a component along with determining a thickness of a nonconductive coating over conductive coatings.

Typically, ECT uses at least one eddy current probe comprising a coil assembly, which generates an oscillating magnetic field that is created by alternating current flow through a wire coil. When the eddy current probe is brought close to a conductive material, such as a metal fuselage, an eddy current in induced in the conductive material. Changes in the metal thickness or any defects in the metal thickness alter the amplitude and pattern of the eddy current along with the resulting magnetic field. The altered amplitude and pattern of the eddy current varies an impedance in the detection coil of the eddy current probe, which can be used by an operator to identify changes and/or defects in the component.

### SUMMARY

Defects can occur in areas that are hard to reach by a rigid eddy current probe assembly. For example, a weld point between a tube and a header may be difficult to access. Similarly, an area that is multiplanar or includes non-planar contours may be difficult to scan with a single scanner geometry, and may involve use of multiple different scanner geometries. Thus, a fixed-geometry handheld scanner may be precluded from use in inspection of areas that are difficult to access.

Fixed-geometry hand-held scanners are generally coupled through cabling to separate equipment, such as a power source, a fault detection system, and a display that outputs the results of the scan. Setup associated with these types of systems along with data download, such as the results of the scan, can present challenges. In particular, after scanning, a user may be required to download the data captured by the probe to a separate fault detection system and then review the results as a separate task. Such systems having separate components can be cumbersome and, due to the bulk associated with these components, may require an additional user to handle management of other components or may involve the user having to switch between scanning and analysis activities without being able to perform both contemporaneously. During a scanning operation, it may be difficult for a user to determine whether or not a proper distance has been maintained between the handheld scanner and the article being inspected. If a proper distance is not maintained, lift-off can occur, which will preclude proper inspection. Thus, a determination may be made that a proper distance was not maintained until well after the inspection when data recorded from the probe is downloaded to the separate fault detection system, resulting in re-work.

Accordingly, what is needed is an inspection device that is capable of inspecting areas that are difficult to reach and able to scan areas that are multiplanar and/or include non-planar contours. Moreover, the inspection system should be able to provide an indication that a proper distance is being maintained during the inspection and the inspection should be able to provide testing data in real time during the inspection.

Examples of the present disclosure relate to a wearable inspection device that can be used to inspect an article. In an embodiment, the wearable inspection device can include an inspection probe, such as an eddy current probe, that may be worn by a user. The wearable inspection device can include a glove where the inspection probe is on a digit, such as a finger of the glove, or on any other portion of the glove, such as a palm of the glove. Moreover, the glove can include probes disposed on more than one digit of the glove or any other location of the glove. In an embodiment, since the probe can be disposed on a digit of a user, the user may be able to inspect hard to reach areas of an article. In addition, by virtue of being on a digit of a user, the user may be able to inspect non-planar areas of an article while at the same time minimizing the possibility of lift-off.

The wearable inspection device can include a monitoring panel, such as an operator interface display, coupled with the inspection probe such that the inspection probe can provide data to the monitoring panel in real time during inspection of an article. In addition, the monitoring panel can display information to a user wearing the inspection probe about the article being inspected, such as defects in the article, in real time during inspection of the article. Thus, the user can conduct an inspection while at the same time gaining an understanding of the condition of the article in real time. The wearable portion can also have an indexing area that can be defined by a status indicator section having status indicators that provide an interface status of the probe with the article. In particular, the status indicators of the indexing area can illuminate when the probe is not at a proper distance relative to the article. Thus, with the status indicator section, a user can readily determine if lift-off has occurred between the probe and the article in real time during inspection of the article.

In another example, the present disclosure relates to a system for inspecting articles. The system can include a wearable portion and a compartment. In an embodiment, the wearable portion can include a glove and a probe, such as an eddy current probe, disposed on a digit of the glove such that a user can use the wearable portion to inspect an article with the probe. The wearable portion can also include a monitoring panel along with an indexing area as discussed above. In an embodiment, the monitoring panel, which can be an operator interface display, can provide real time data related to the inspection of the article with the probe to a user. The indexing area can indicate an interface status of the probe with the article. Thus, a user may employ the indexing area to minimize data loss associated with lift-off. The compartment can be a carrying case configured to be worn by a user of the wearable portion. In an embodiment, the compartment can include a flaw detector that can be coupled with the probe and a power source that can provide power to the flaw detector, the probe, and the monitoring panel.

### BRIEF DESCRIPTION OF FIGURES

FIGS. 1A-1C illustrate a glove scanner, in accordance with at least one example of the present disclosure.

FIG. 2 illustrates a coil that may be used with a probe of the glove scanner of FIGS. 1A and 1B, in accordance with at least one example of the present disclosure.

FIG. 3 illustrates a plurality of coils that may be used with a probe of the glove scanner of FIGS. 1A and 1B, in accordance with at least one example of the present disclosure.

FIGS. 4A-4C illustrate arrays of coils that can be used with a probe of the glove scanner of FIGS. 1A and 1B, in accordance with examples of the present disclosure.

FIG. 5 illustrates a selector that can be used with the arrays of coils of FIGS. 4A-4C, in accordance with examples of the present disclosure.

FIG. 6 illustrates the inspection of the article using a probe of the glove scanner of FIGS. 1A and 1B, in accordance with examples of the present disclosure.

FIGS. 7-10 shows an assembly that may be used to couple an operator interface of the glove scanner of FIGS. 1A and 1B, in accordance with examples of the present disclosure.

FIG. 11 illustrates a system for inspecting an article, where the system includes a compartment in communication with the glove scanner of FIG. 1, in accordance with examples of the present disclosure.

FIG. 12 illustrates the compartment in FIG. 11 in greater detail, where various features of the compartment, such as electronics, a power source, and storage are shown, in accordance with examples of the present disclosure.

FIGS. 13A and 13B illustrate a glove scanner, in accordance with alternative examples of the present disclosure.

FIGS. 14-22 illustrate a glove scanner, in accordance with alternative examples of the present disclosure.

### DETAILED DESCRIPTION

Examples of the present disclosure relate to a wearable inspection device that can be used to inspect an article. In an embodiment, the wearable inspection device can include an inspection probe, such as an eddy current probe, that may be worn by a user. The wearable inspection device can include a glove where the inspection probe is on a digit, such as a finger of the glove, or on any other portion of the glove, such as a palm of the glove. Moreover, the glove can include probes disposed on more than one digit of the glove or any other location of the glove. In an embodiment, since the probe can be disposed on a digit of a user, the user may be able to inspect hard to reach areas of an article. In addition, by virtue of being on a digit of a user, the user may be able to inspect non-planar areas of an article while at the same time minimizing the possibility of lift-off.

The wearable inspection device can include a monitoring panel coupled with the inspection probe such that the inspection probe can provide data to the monitoring panel in real time during inspection of an article. In an embodiment, the inspection probe can couple with the monitoring panel through a variety of means. For example, the inspection probe can be hardwired with the monitoring panel using any type of cable capable of sending and receiving electronic signals. Moreover, the inspection probe can be coupled to a wireless transceiver/receiver that wirelessly communicates with a wireless transceiver/receiver coupled with the monitoring panel. In addition, the monitoring panel can display information to a user wearing the inspection probe about the article being inspected, such as defects in the article, in real time during inspection of the article. Thus, the user can conduct an inspection while at the same time gaining an understanding of the condition of the article in real time. The wearable portion can also have an indexing area that can be defined by a status indicator section having status indicators that provides an interface status of the probe with the article. In particular, the indexing area can illuminate when the probe is not at a proper distance relative to the article. Thus, with the indexing area, a user can readily determine if lift-off has occurred between the probe and the article in real time during inspection of the article.

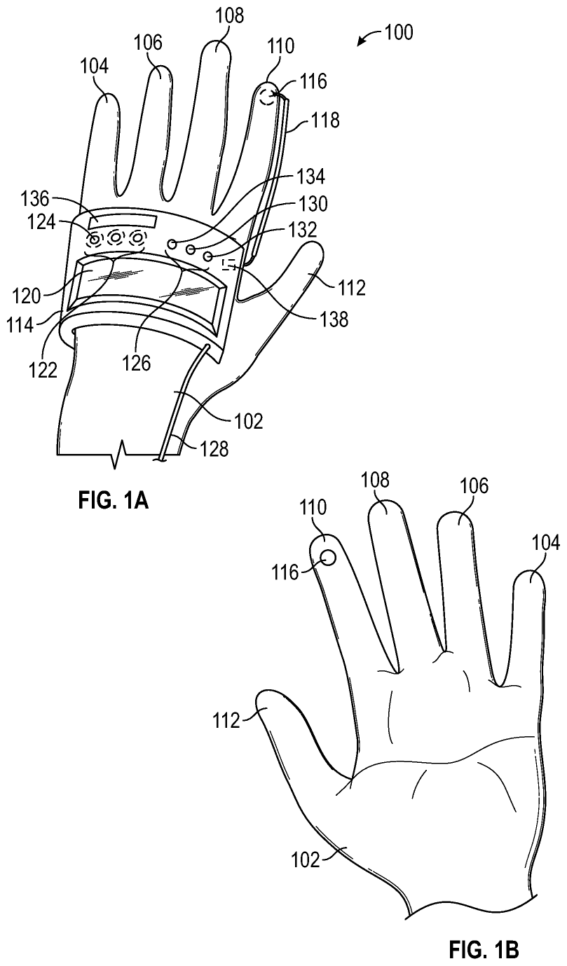

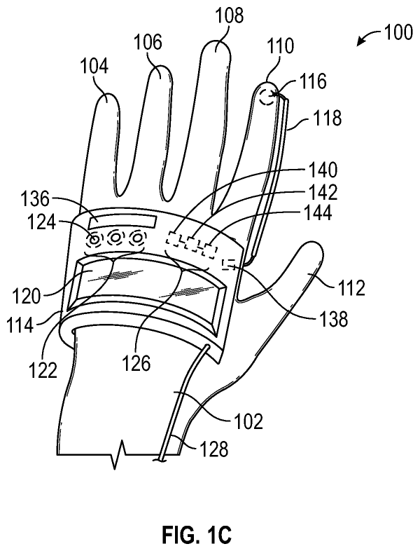

An example of wearable inspection device is shown with reference to FIGS. 1A and 1B, which illustrate front and back sides of a wearable inspection device 100 according to an embodiment of the present disclosure. In an embodiment, the wearable inspection device 100 can include a wearable portion 102 that can include digits 104-112. In an embodiment, the digits can correspond to the fingers of the hand of a user. For example, in a left hand configuration, the digit 104 can correspond to the little finger of a user, the digit 106 can correspond to the ring finger of a user, and the digit 108 can correspond to the middle finger of a user. Moreover, in a left hand configuration, the digit 110 can correspond to the index finger of a user while the digit 112 can correspond to the thumb of a user. It should be noted that while a left hand configuration is illustrated, embodiments also envision a right hand configuration, which would be a mirror version of the wearable inspection device 100 shown in the Figures. The wearable inspection device 100 can also include an operator interface 114 that can be coupled with a probe 116 disposed at the digit 110 of the wearable portion 102 via a connector 118. The operator interface 114 can include a display 120 along with a probe status indicator section 122 that can have indicators 124. The operator interface 114 can also include controls 126 and an electrical connector 128. In an embodiment, the connector 118 can be any type of electrical wiring capable of providing voltage and current to the probe 116. Examples of the connector 118 can also be a 16-way connector available from Lemo S.A. headquartered in Ecublens, Switzerland or a Bayonet Neill-Concelman connector.

In an embodiment, the controls 126 can be used to control the probe 116 during the inspection of an article. To further illustrate, the controls 126 can include a start button 130, a pause button 132, and a stop button 134. It should be noted that while the start button 130, the pause button 132, and the stop button 134 are shown as having the linear configuration in FIG. 1, the start button 130, the pause button 132, and the stop button 134 can have any configuration, such as a circular configuration, a triangular configuration, or the like. In an embodiment, the start button 130 can be used to start an inspection of an article with the wearable inspection device 100. The pause button 132 can be used to pause an inspection of an article with the wearable inspection device 100. In an embodiment, the stop button 134 can be used to end an inspection of an article with the wearable inspection device 100.

In an alternative embodiment, instead of the start button 130, the pause button 132, and the stop button 134, the wearable inspection device 100 can include a voice receiver circuit 140, a control circuit 142 coupled with the voice receiver circuit 140, and a transmitter 144 coupled with the control circuit 142, as shown with reference to FIG. 1C. Here, the voice receiver circuit 140 can be configured to receive voice commands from the user. In an embodiment, the receiver circuit 140 can be configured to communicate with the control circuit 142 and transmit a signal in response to the voice command to the control circuit 142. In response to receiving the signal, the control circuit 142 is configured to either activate article inspection or deactivate article inspection with the wearable inspection device 100. Specifically, the control circuit 142 can control the transmitter 144 to transmit control data related to the voice commands to the probe 116. Thus, in response to a voice command received from a user, inspection with the wearable inspection device 100 may be activated or deactivated.

In an embodiment, the connector 128 can be any type of electrical wiring capable of providing voltage and current to the operator interface 114 and the probe 116. Examples of the connector 128 can be a 16-way connector available from Lemo S.A. headquartered in Ecublens, Switzerland or a Bayonet Neill-Concelman connector.

In an embodiment, the wearable portion 102 can be a glove where the digits 104-112 can be fingers of the glove. Thus, when the wearable portion 102 is a glove, a user can insert their hand into the wearable portion 102 and control the probe 116 with any of their fingers corresponding to the digits 104-112 that may include the probe 116. While the wearable portion 102 is described as being a glove, it should be noted that the wearable portion 102 may take the form of any type of hand covering, such as a mitten, a fingerless glove, or the like.

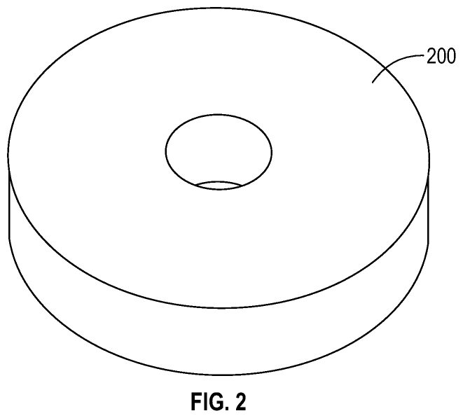

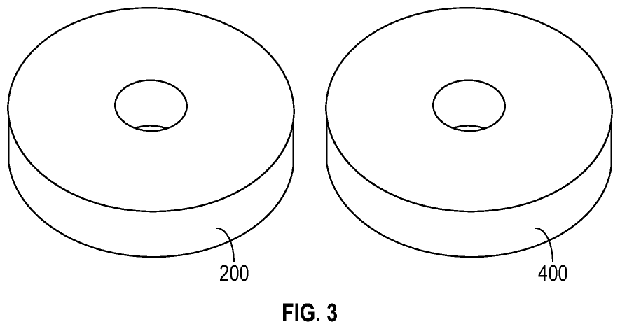

The probe 116 can be an eddy current probe that can be used to inspect an article. Examples of an article can include pipes, a fixture having a tubing and headers, an airplane fuselage, components for railway cars, and the like. The probe 116 can be used to inspect for defects in an article, such as fissures, voids, and the like. In particular, as discussed with reference to FIG. 2, the probe 116 can include a coil 200 that may operate in one of a bridge mode, a transmit-receive mode, or in a differential transmit-receive mode. Moreover, in a further embodiment, the probe 116 can include the coil 200 and a coil 300, as shown with reference to FIG. 3. In the embodiment of FIG. 3, instead of including a single 200, the probe 116 can include tow coils, the coil 200 and the coil 300.

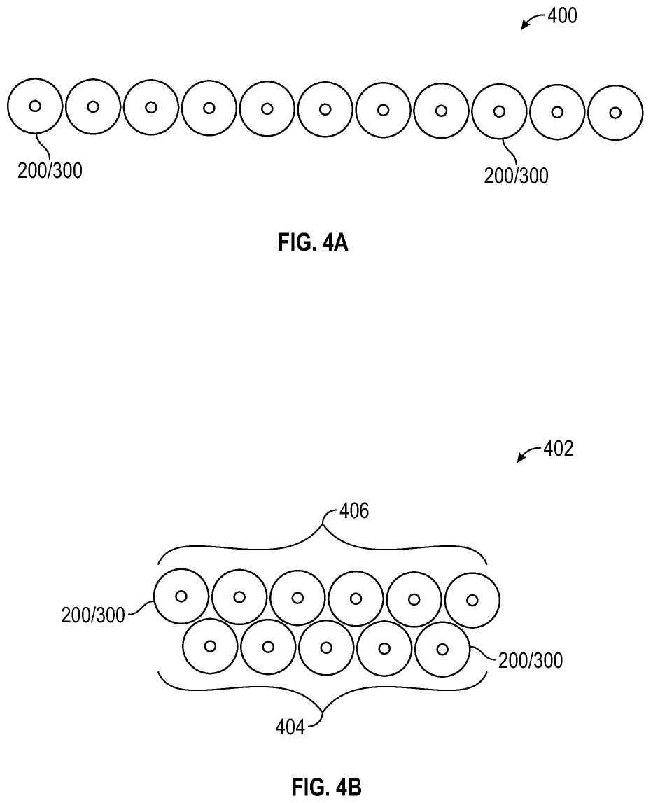

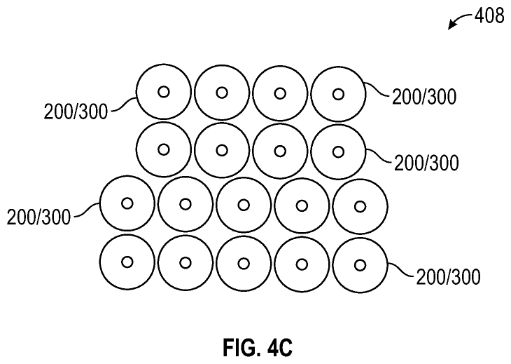

In addition, coils of the probe 116 may have an array configuration as shown with reference to FIGS. 4A-4C. For example, in FIG. 4A, the coils 200 or the coils 400 may be arranged in a line to form an array 400. In addition, the coils 200 or the coils 400 may be arranged in two offset lines to form an array 402 as shown with reference to FIG. 4B. In the embodiment of FIG. 4B, the array 402 can be defined by a row 404 of the coils 200 and 400 along with a row 406 of the coils 200 and 400. As may be seen with reference to FIG. 4B, the row 404 can be offset from the row 404. Moreover, the probe 116 can have an array of coils having any number of rows, as shown with reference to FIG. 4C and an array 408. It should be noted that while only two rows (FIG. 4B) and four rows (FIG. 4C) of arrays are shown, an array can have any number of arrays with any number of coils 200 in each of the arrays in accordance with embodiments.

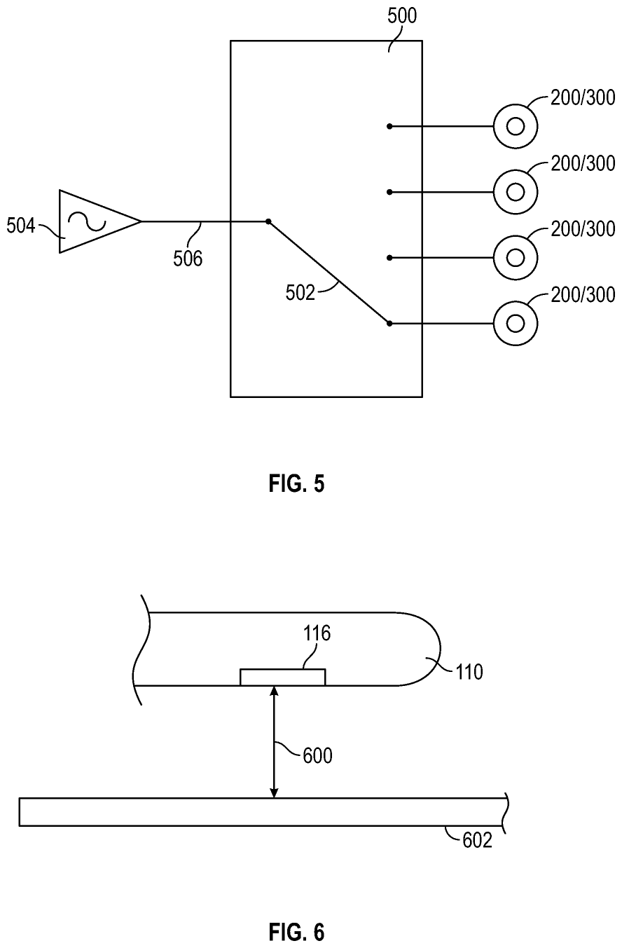

In an embodiment where the probe 116 includes an array of coils, such as the arrays 400, 402 and 408 shown with reference to FIGS. 4A-4C, the probe 116, or in the alternative, the wearable inspection device 100, can include a selector 500 that provides a generator signal 506 from a generator 504 to arrays of coils, such as the array 400, 402, and 408 of the coils 200/300, as shown with reference to FIG. 5. In an embodiment, the selector 500 can respectively drive each of the coil 200 during operation of the probe 116, as shown with reference to a switch 502 of the selector 500 where the selector 500 can move the switch 502 between the generator signal 506 and each of the coils 200/300. In addition, the selector 500 can also monitor the coils during a switching action of the switch 502. In particular, the selector 500 can monitor the input, such as the generator signal 506, provided to the coils 200/300. Moreover, the selector 500 can monitor the output from the coils 200/300 during inspection.

As discussed with reference to FIGS. 3-4C, the probe 116 can have a number of configurations. As described herein, the wearable inspection device 100 include the probe 116. Moreover, as will be discussed further on, the digits 104-110 can include a plurality of the probes 116. In embodiments, the probe 116 can include the configurations discussed with reference to FIGS. 3-4C. Thus, when reference is made to the probe 116, it should be understood that the probe 116 can include any of the configurations discussed with regards to FIGS. 3-4C. Similarly, it should be understood that any reference to a plurality of probes refers to probes that can include any of the configurations discussed with regards to FIGS. 3-4C.

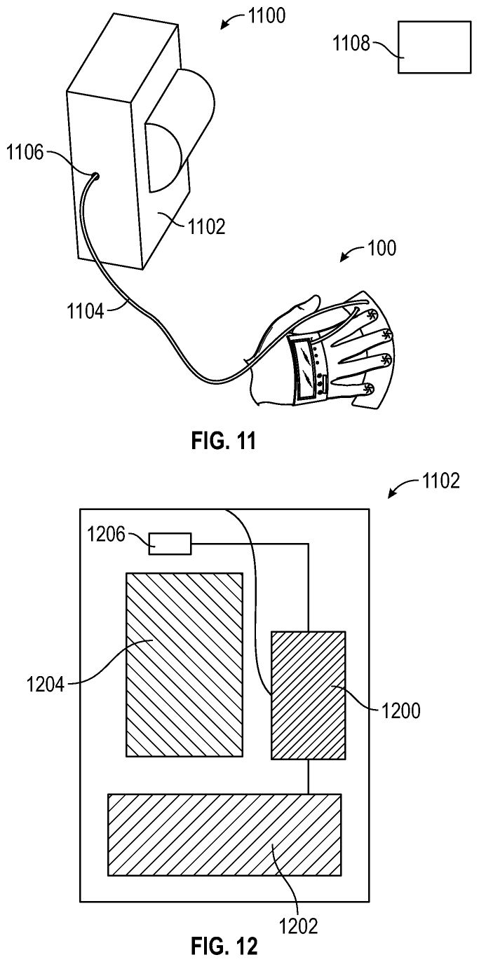

Returning attention to FIGS. 1A and 1B and the wearable inspection device 100, the operator interface 114 can include the operator interface display 120, which can display information relating to a status of the probe 116 and the article being inspected by the probe 116. For example, as a user is inspecting an article with the probe 116, the operator interface display 120 can display the results of the inspection in real time, such as whether or not there are any defects in the article being inspected by the probe 116. In an embodiment, the operator interface 114 can be in communication with an article inspection system 1100 (FIG. 11) that can analyze data obtained by the probe 116 and output the analyzed data. In an embodiment, the analyzed data can reflect whether or not defects are present in the article being inspected by the probe 116. The operator interface display 120 can display the analyzed data output by the analysis device in a manner that is decipherable by the user of the wearable inspection device 100. Thus, the user can view the analysis of the inspection by the probe 116 in real time. Moreover, the user does not need to turn their attention to another device in order to examine the results during use of the wearable inspection device 100 since the operator interface display 120 can be in the line of sight of the user during inspection of an article with the wearable inspection device 100.

The operator interface 114 can also include the status interface section 122 that can include the status indicators 124. In an embodiment, the combination of the status interface section 122 and the status indicators 124 can comprise an indexing area. It should be noted that in addition to the configuration shown with reference to FIG. 1, the status interface section 122 and the status indicators can be located on any of the digits 104-112. In an embodiment, the status indicators 124 may be lights, such as light emitting diodes, that indicate a status of the probe 116 relative to an article being inspected. For example, in an embodiment where the probe 116 is an eddy current probe, making reference to FIG. 6, in order to accurately inspect an article, the probe 116 must be a minimum distance 600 from an article 602 in order to accurately detect defects in the article 602. In an embodiment, when a distance between the probe 116 and the article 602 is greater than the minimum distance 600, a lift-off condition occurs, where the probe 116 may not be able to accurately detect defects in the article 602. In an embodiment, when a distance between the probe 116 and the article 602 exceeds the minimum distance 600, the status indicators 124 can provide an indication, such as through illumination in embodiments where the status indicators are lights, that the distance between the probe 116 and the article 602 exceeds the minimum distance 600. In an embodiment, the minimum distance 600 can be in a range of about 0.1 mm to about 3.0 mm. In some embodiments, the operator interface 114 can include a power source 136 such that the operator interface 114 can provide current and voltage to the probe 116 during operation of the wearable inspection device 100. In an embodiment, the power source 136 can be any type of battery, such as rechargeable or non-rechargeable batteries, which can include alkaline batteries, lithium based batteries, zinc based batteries, nickel based batteries, or lead based batteries.

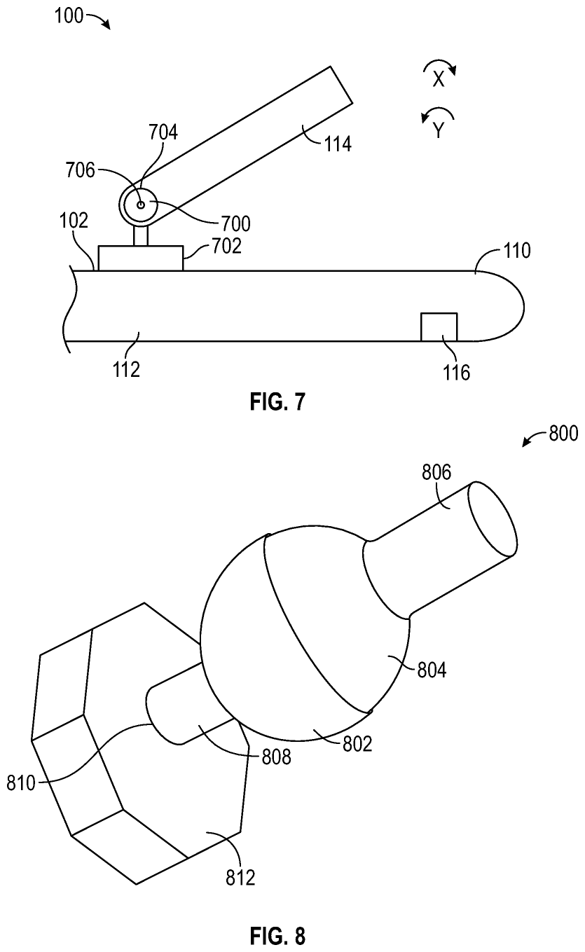

Moreover, the operator interface 114 can be pivotably mounted to the wearable portion 102 of the wearable inspection device 100 as shown with regards to FIG. 7. In particular, the wearable inspection device 100 can include a coupling 700 that couples the operator interface 114 with a mount 702 on the wearable portion 102, as shown with reference to FIG. 7. The operator interface 114 can include a bore 704 that can hold the coupling 700. In an embodiment, the bore 704 can have a cylindrical configuration and the coupling 700 can have a cylindrical configuration that is complementary to the cylindrical configuration of the bore 704. When the coupling 700 is disposed within the bore 704, the operator interface 114 may pivot about the coupling 700 along a direction X and a direction Y. In an embodiment, a user of the wearable inspection device 100 can adjust the operator interface 114 during use of the wearable inspection device 100 in order to provide a better viewing angle of the operator interface 114. In an embodiment, the mount 702 includes a portion 706 extending therefrom to the coupling 700, thus connecting the coupling 700 with the mount 702, as may be seen with respect to FIG. 7.

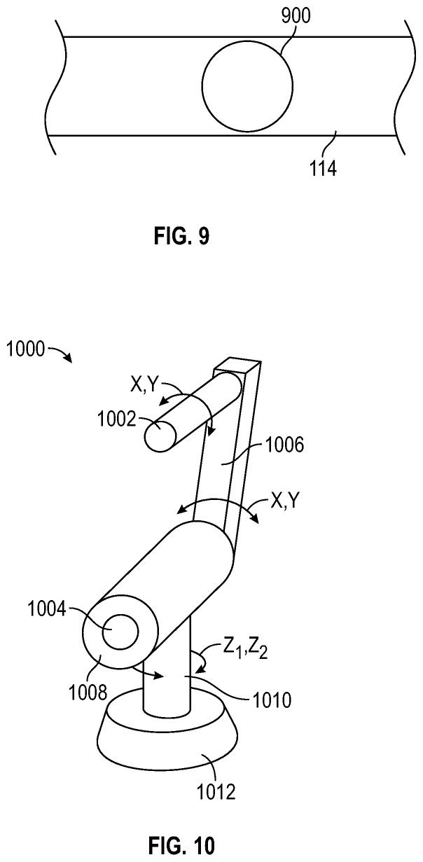

Besides the mount 702 and the mount portion 706, the operator interface 114 can also mount to the wearable inspection device 100 using a ball socket configuration, as shown with reference to FIGS. 8 and 9. Now making reference to FIG. 8, the operator interface 114 can detachably couple with the wearable inspection device 100 via a coupling assembly 800 that includes a ball 802 disposed within a socket 804. Here, the coupling assembly 800 includes an interface 806 having a cylindrical configuration extending from the socket 804. In an embodiment, the operator interface 114 can include a recess 900 (FIG. 9) having a cylindrical configuration that is complementary to the cylindrical configuration of the interface 806 in order to accept the interface 806 such that the operator interface 114 can couple with the coupling assembly 800. In addition, the ball 802 can include an interface 808 having a cylindrical configuration extending therefrom. In an embodiment, the mount 702 can include a recess 810 having a cylindrical configuration that is complementary to the cylindrical configuration of the interface 808 in order to accept the interface 808 such that the coupling assembly 800 can couple with a mount 812 of the wearable inspection device 100. In an embodiment, the ball 802 can rotate within the socket 804 such that the operator interface 114 can be adjustable in three dimensions. Moreover, the interface 808 can threadingly couple with the mount 702 such that the coupling assembly 800 and the operator interface 114 can be detachable from the wearable inspection device 100.

In addition to the embodiment discussed with reference to FIGS. 8 and 9, the operator interface 114 can couple with the wearable inspection device 100 with a coupling assembly 1000, as shown with reference to FIG. 10. In this embodiment, the coupling assembly 1000 can include a pivot 1002 that couples with the operator interface 114 via the bore 704. In an embodiment, the operator interface 114 can rotate about the pivot 1002 along the directions X and Y. The coupling assembly 1000 can also include a pivot 1004 coupled with the pivot 1002 via a link 1006. In an embodiment, the pivot 1004 can be disposed within a sleeve 1008 such that the pivot can rotate along the directions X and Y within the sleeve 1008. The sleeve 1008 may be rigidly coupled with a link 1010 that detachably couples with a mount 1012 of the wearable inspection device 100. In an embodiment, the sleeve 1008 can couple with the link 1010 with a soldering technique, a welding technique, or any other suitable technique that allows rigid coupling of the sleeve 1008 with the link 1010. The link 1010 can threadingly couple with the mount 1012 such that the coupling assembly 1000 and the operator interface 114 are detachable from the wearable inspection device 100.

While the operator interface 114 has been described as being coupled with the wearable inspection device 100, it should be noted that in alternative embodiments, information may be provided to an operator of the wearable inspection device 100 with a Heads Up Display (HUD). In an alternative embodiment, the HUD may be worn on the head of an operator of the wearable inspection device 100. Here, the HUD may be a visor or eyeglasses and provide the same information as the operator interface 114. It should be noted that the HUD may be provided in addition to the operator interface 114 or as an alternative to the operator interface 114.

In alternative embodiments, the wearable inspection device 100 may form a part of an article inspection system 1100, as shown with reference to FIG. 11. In an embodiment, the article inspection system 1100 can include the wearable inspection device 100 along with a compartment 1102. In an embodiment, the compartment 1102 can be a bag, such as a backpack or any other type of bag that is capable of being worn or carried by a user of the wearable inspection device 100. Further examples of the compartment 1102 can include a vest or a belt. The article inspection system 1100 can also include a connector 1104, which can provide voltage and current to the operator interface 114 and the probe 116. In an embodiment, the connector 1104 can be any type of electrical wiring capable of providing voltage and current to the operator interface 114 and the probe 116. Examples of the connector 128 can also be a 16-way connector available Lemo S.A. headquartered in Ecublens, Switzerland or a Bayonet Neill-Concelman connector. Moreover, the connector 1104 can be coupled to a detachable interconnect 1106 in order to facilitate connection and disconnection of the wearable inspection device 100 from the compartment 1102.

The compartment 1102 can hold various components for the article inspection system 1100, as shown with reference to FIG. 12. In particular, the compartment 1102 can store electronics 1200, a power source 1202, and include storage 1204. In an embodiment, the electronics 1200 can include an analysis device that receives data from the probe 116 during inspection of the article 602 via the operator interface 114 and the connector 1104. The analysis device can analyze the data and determine whether or not any defects exist in the article 602. The analysis device can be any flaw detector capable of inspecting articles relating to flaw detection of surface and near-surface defects. An example of the electronics 1200 that can be used includes the Nortec 600 available from Olympus Corporation of the Americas headquartered in Center Valley, Pa.

The power source 1202 can provide power to the electronics 1200 and provide power to the operator interface 114 and the probe 116. The power source 1202 can provide power to the operator interface 114 and the probe 116 via electrical wiring of the connector 1104. In an embodiment, the power source 1202 can be any type of battery, such as rechargeable or non-rechargeable batteries, which can include alkaline batteries, lithium based batteries, zinc based batteries, nickel based batteries, or lead based batteries.

As noted above, in some embodiments, the operator interface 114 can include the power source 136 such that the operator interface 114 can provide current and voltage to the probe 116 during operation of the wearable inspection device 100. In an embodiment where the operator interface 114 can include the power source 136, the article inspection system 1100 may not include the power source 1202. Moreover, in an embodiment, instead of the electronics 1200 receiving data from the operator interface 114 and the probe 116 via the connector 1104, the operator interface 114 can wirelessly transmit the data to the electronics 1200 via a wireless transmitter/receiver 138 (FIG. 1A). In an embodiment, the article inspection system 1100 can include a wireless transmitter/receiver 1206 that can wirelessly communicate with the transmitter/receiver 138. In an embodiment, the transmitter/receiver 138 can send data detected from the probe 116 to the transmitter/receiver 1206, which can then provide the data to the electronics 1200 for defect detection. Moreover, the electronics 1200 can provide results from the defect detection to the transmitter/receiver 1206, which can then send the results to the operator interface 114 for display at the operator interface display 120. In an embodiment, each of the transmitter/receiver 138 and the transmitter/receiver 1206 may be any type of transmitter/receiver capable of short range communications, such as any type of IEEE 802 communication standard. Moreover, in an embodiment, the electronics 1200, in combination with the transmitter/receiver 1206, can function as a gateway device that wirelessly communicates with a remote server 1108. Therefore, in an embodiment, the electronics 1200 can wirelessly transmit the results of an inspection performed by the wearable inspection device 100 to a remote location for further analysis.

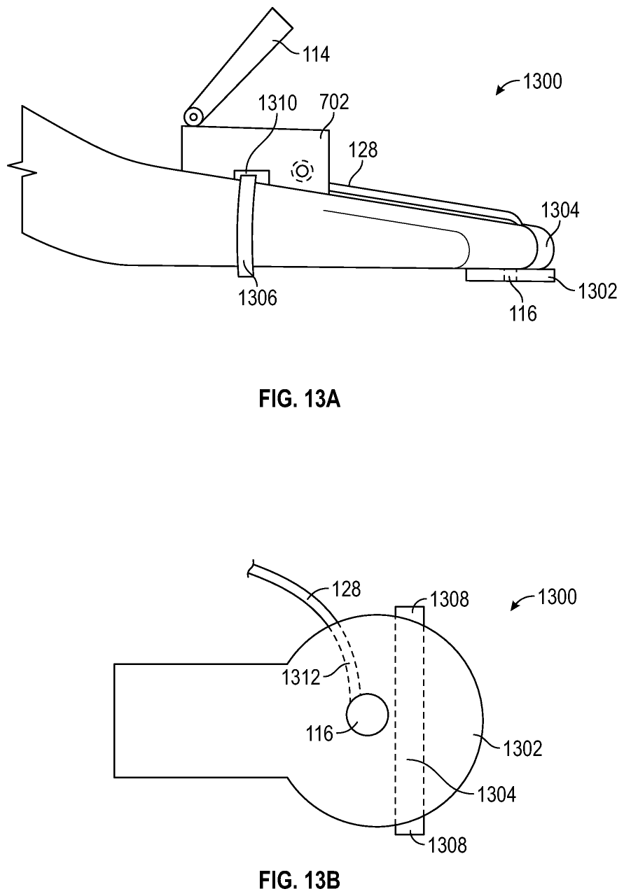

In the embodiments discussed above, the wearable inspection device 100 can include the wearable portion 102, such as a glove, to be worn by a user, where the operator interface 114 and the probe 116 are disposed on the wearable portion 102. Embodiments of the present disclosure provide a wearable inspection device 1300 that does not include a wearable portion 102. In this embodiment, the operator interface 114 and the probe 116 can attach directly to the hand of a user of the wearable inspection device 1300, as shown with reference to FIG. 13A. In this embodiment, the wearable inspection device 1300 can include an interface 1302 where the probe 116 can be disposed at the interface 1302. In addition, the wearable inspection device 1300 can include straps 1304 and 1306 that are each configured to engage with an appendage of a user. For example, the strap 1304 can be configured to receive a finger of a user. Moreover, the strap 1306 can be configured to receive a hand of the user. In an embodiment, each of the straps may be formed of a material that is suitable to couple with an appendage of the user. Examples include a Velcro™ strap, an elastic band, a buckle configuration, or the like.

The strap 1304 can couple with the interface 1302 at anchor points 1308 (FIG. 13B). In an embodiment, the strap 1304 can couple with the interface 1302 at the anchor points 1308 with soldering, spot welding, fasteners, or an adhesive such as an epoxy, a glue, or the like. The strap 1306 can couple with the operator interface 114 at anchor points 1310. In an embodiment, the strap 1306 can couple with the operator interface 114 at the anchor points 1310 with soldering, spot welding, fasteners, or an adhesive such as an epoxy, a glue, or the like. Moreover, the probe 116 can couple with the operator interface 114 via the electrical connector 128. In the embodiment shown with reference to FIGS. 13A and 13B, the interface 1302 can include an electrical connection 1312 formed therein that can electrically couple with the electrical connection 128. In addition, the electrical connection 1312 can electrically couple with probe 116. In an embodiment, the electrical connection 1312 can be a conductive trace formed in the interface 1302 using any well-known technique.

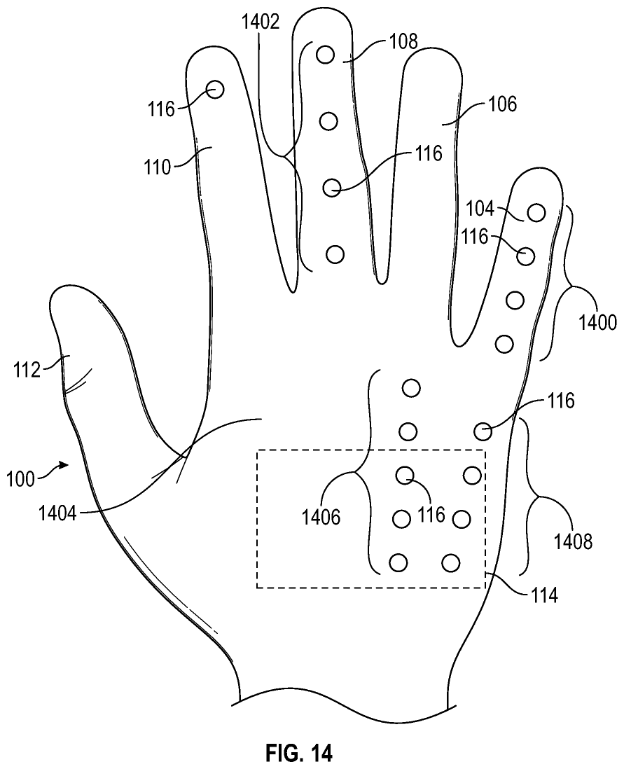

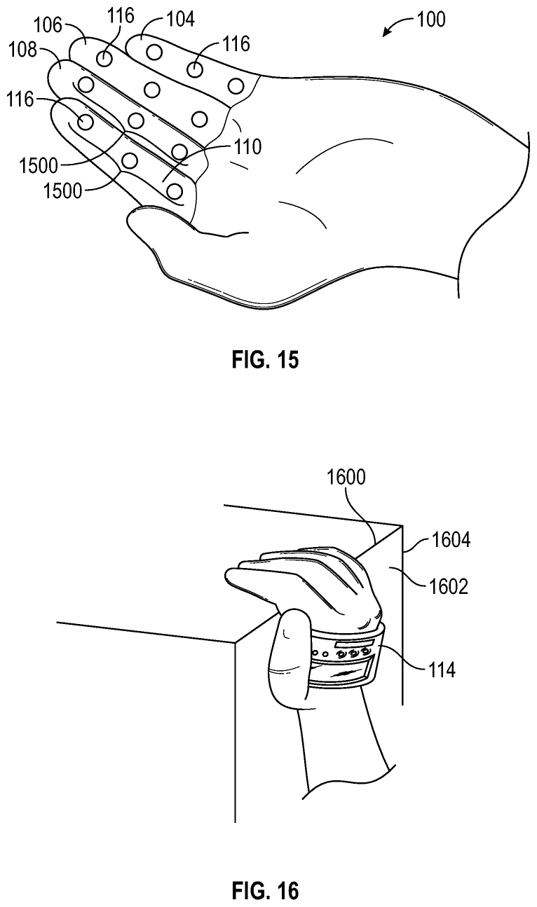

In the embodiments described above, the wearable inspection device 100 included a single probe 116. However, in alternative embodiments, the wearable inspection device 100 can include any number of probes 116 in any configuration. For example, the wearable inspection device 100 can include a plurality of probes 1400 that include the probes 116 disposed on the digit 104 and a plurality of probes 1402 that include the probes 116 disposed on the digit 108, as shown with reference to FIG. 14. It should be noted that in addition to the digits 104 and 108 having a plurality of probes, such as the plurality of probes 1400 and 1402, all of the digits 104-112 can include a plurality of probes similar to the plurality of probes 1400 and 1402, as shown with reference to FIG. 15, where the digits 104-110 include a plurality of probes 1500. When the digits 104-110 have the configuration with the plurality of probes as shown with reference to FIGS. 14 and 15, the wearable inspection device 100 can be used to inspect outside corners 1600 and 1604 of an article 1602, as shown with regards to FIG. 16.

It should be noted that while the digits 104 and 108 are shown as having the plurality of probes 1400 and 1402 in FIG. 14 and the digits 104-110 are shown as having the plurality of probes 1500, any combination of the digits 104-112 can include a plurality of probes. For example, the digits 104, 108, and 112 may only have a plurality of probes while the digits 106 and 110 can have no probes or only one probe. In an embodiment, including the plurality of probes 1400 and 1402 on the digits 104 and 108 can allow for inspection of a greater area with a single motion of the wearable inspection device 100.

Returning attention to FIG. 14, a palm side of the wearable inspection device 100 shown with reference to FIG. 1A is illustrated. In particular, FIG. 14 illustrates the side of the wearable inspection device 100 that is opposite to the side of the wearable inspection device 100 shown with reference to FIG. 1A, where a palm 1404 of the wearable inspection device 100 is shown. In an embodiment, the wearable inspection device palm 1404 can include a plurality of probes 1406 and 1408 that include the probes 116. Moreover, the wearable inspection device palm 1404 can include only one of the plurality of probes 1406 and 1408. The wearable inspection device palm 1404 can also include additional pluralities of probes.

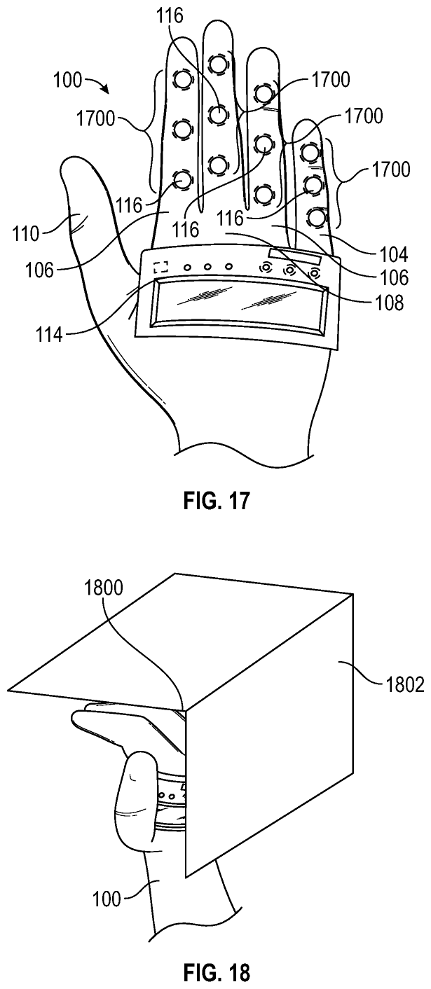

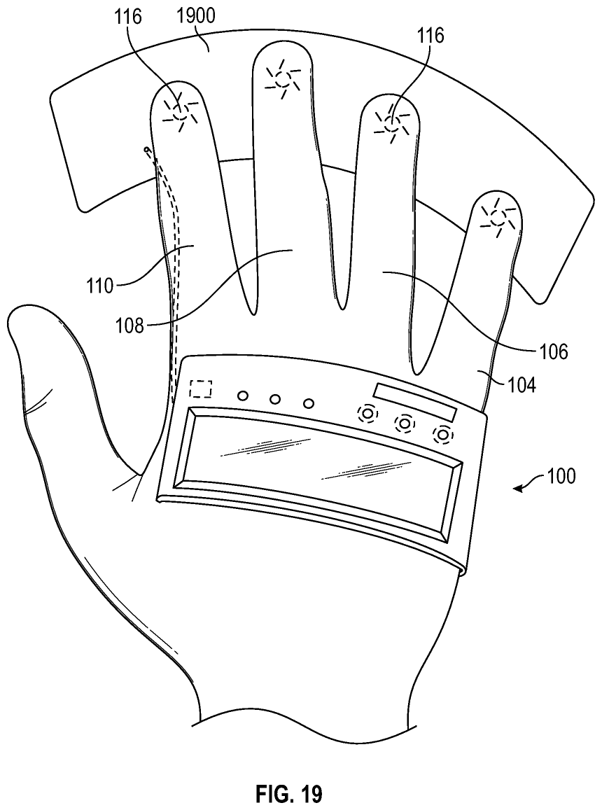

In addition to the digits 104-110 including the plurality of probes 1500 on the wearable inspection device palm 1404 of the wearable inspection device 100, the digits 104-110 can include a plurality of probes 1700 on a side of the wearable inspection device 100 on which the operator interface 114 is disposed, as shown with reference to FIG. 17. As shown, each of the digits 104-110 can include the plurality of probes 1700. However, it should be noted that while the digits 104-110 are shown as having the plurality of probes 1700, any combination of the digits 104-112 can include a plurality of probes. For example, the digits 104, 108, and 112 may only have a plurality of probes while the digits 106 and 110 may not include probes or only one probe. In an embodiment, including the plurality of probes 1700 on the digits 104 and 108 allows for inspection of a greater area with a single motion of the wearable inspection device 100. Moreover, in embodiments where the wearable inspection device 100 includes the configuration shown with reference to FIG. 17, the wearable inspection device 100 can be used to inspect an inside corner 1800 of an article 1802, as shown with reference to FIG. 18.

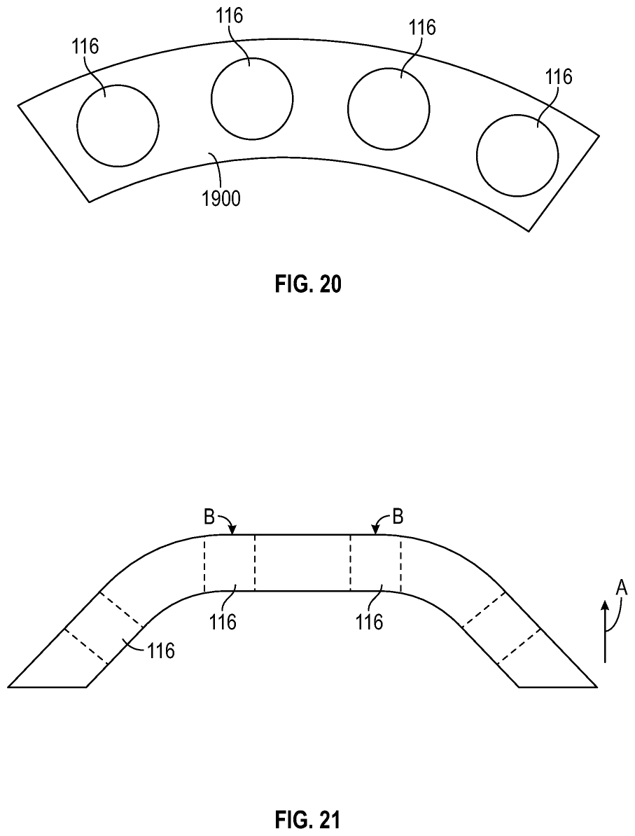

In addition to integrating the probes 116 with the wearable inspection device 100 as discussed above, an eddy current array flexible probe 1900 that includes the probes 116 can be integrated with the wearable inspection device 100, as shown with reference to FIGS. 19-21. In an embodiment, the eddy current flexible array probe 1900 can include the probes 116 that align with positions of the digits 104-110, as shown with reference to FIGS. 19 and 20. Moreover, the eddy current flexible array probe 1900 can be formed from a flexible material, such as a flexible printed circuit board (PCB) material formed of copper layers and plastic layers or any other material that may allow for adjusting by the digits 104-110. Thus, the eddy current flexible array probe 1900 can flex in a direction A as shown with the reference to FIG. 21. In an embodiment, when the eddy current flexible array probe 1900 flexes as shown with regards to FIG. 21, at least one of the probes 116 can maintain a flat surface B in order to inspect an area of article. In an embodiment, by virtue of the flexible nature of the eddy current flexible array probe 1900, when the wearable inspection device 100 includes the eddy current flexible array probe 1900, the wearable inspection device 100 can be used to inspect areas that are difficult to reach. For example, in an embodiment where the wearable inspection device 100 includes the eddy current flexible array probe 1900, the wearable inspection device 100 can be used to inspect the outside corners 1600 and the inside corners 1800.

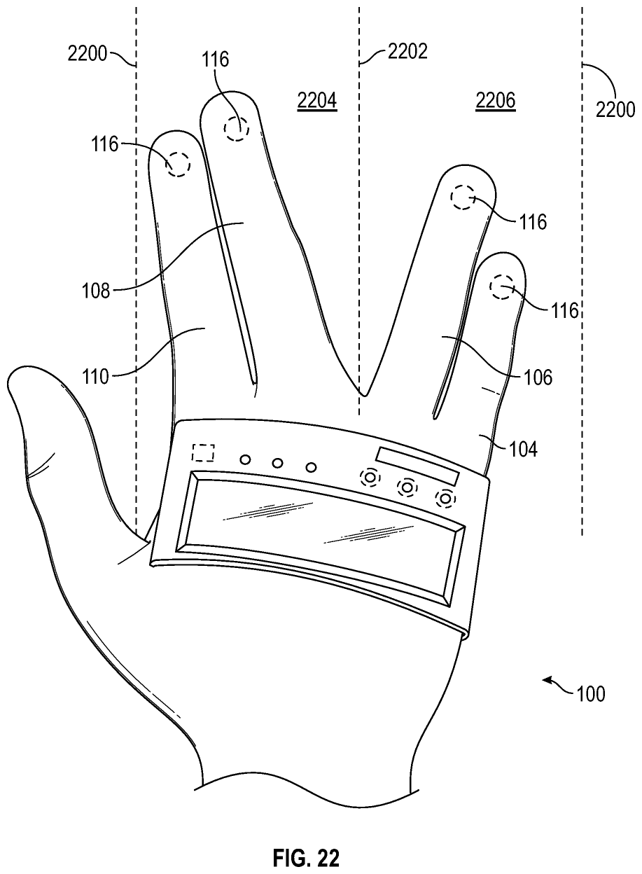

In accordance with embodiments, the wearable inspection device 100 can inspect areas that are difficult to reach and can scan areas that are multiplanar and/or include non-planar contours. In addition, by virtue of the digits 104-110 including the probes 116, different digits can simultaneously inspect different areas of an article, such as when an area requiring inspection includes an obstruction, as shown with reference to FIG. 22. Here, the wearable inspection device 100 can be used to inspect an article 2200 having an obstruction 2202. In an embodiment, a user of the wearable inspection device 100 may wish to inspect areas 2204 and 2206 divided by the obstruction 2202. In an embodiment, the obstruction 2202 can be a weld seam, a plurality of fasteners, a surface that is non-planar or has a shape that is different from the article areas 2204 and 2206, or any other type of obstruction. Regardless of the type of obstruction, the digits 104-110 can be separated as shown such that the wearable inspection device 100 may be used to inspect the article 2200 while working around the obstruction 2202. It should be noted that while FIG. 22 illustrates the digits 104 and 106 grouped together and the digits 108 and 110 grouped together such that the digits 106 and 108 are separated from each other, any combination of groupings of the digits 104-110 and separation of the digits 104-110 are envisioned, such as grouping the digits 104-108 and separating the digit 108 from the digit 110, and the like.

Moreover, in some embodiments, the wearable inspection device 100 can be used to inspect areas of an article that are not visible to a user of the wearable inspection device 100. In order to account for the lack of visual contact with the wearable inspection device 100 during inspection of an article, embodiments of the wearable inspection device 100 can include positioning sensors at the location of the probes 116. In particular, the wearable inspection device 100 can include an encoder, which can provide location information to the electronics 1200. In an embodiment, the electronics 1200 can output a position of the wearable inspection device 100 relative to an article being inspected to a user. Therefore, the user of the wearable inspection device 100 can use this information to guide the wearable inspection device 100 along an article during inspection without having visual contact with the wearable inspection device 100.

The above detailed description includes references to the accompanying drawings, which form a part of the detailed description. The drawings show, by way of illustration, specific examples in which the invention can be practiced. These examples are also referred to herein as examples. Such examples can include elements in addition to those shown or described. However, the present inventor also contemplates examples in which only those elements shown or described are provided. Moreover, the present inventor also contemplates examples using any combination or permutation of those elements shown or described (or one or more aspects thereof), either with respect to a particular example (or one or more aspects thereof), or with respect to other examples (or one or more aspects thereof) shown or described herein.

In this document, the terms a or an are used, as is common in patent documents, to include one or more than one, independent of any other instances or usages of at least one or one or more. In this document, the term or is used to refer to a nonexclusive or, such that A or B includes A but not B, B but not A, and A and B, unless otherwise indicated. In this document, the terms including and in which are used as the plain-English equivalents of the respective terms comprising and wherein. Also, in the following claims, the terms including and comprising are open-ended, that is, a system, device, article, composition, formulation, or process that includes elements in addition to those listed after such a term in a claim are still deemed to fall within the scope of that claim. Moreover, in the following claims, the terms first, second, and third, etc. are used merely as labels, and are not intended to impose numerical requirements on their objects.

The above description is intended to be illustrative, and not restrictive. For example, the above-described examples (or one or more aspects thereof) may be used in combination with each other. Other examples can be used, such as by one of ordinary skill in the art upon reviewing the above description. The Abstract is provided to comply with 37 C.F.R. § 1.72(b), to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed example. Thus, the following claims are hereby incorporated into the Detailed Description as examples or examples, with each claim standing on its own as a separate example, and it is contemplated that such examples can be combined with each other in various combinations or permutations. The scope of the invention should be determined with reference to the appended claims, along with the full scope of equivalents to which such claims are entitled.

What is claimed:

1. A wearable inspection device for inspecting an article, the device comprising:
a wearable portion;
at least one eddy current probe attached to in part at the wearable portion;
a connector extending from the at least one eddy current probe;
an operator interface coupled with the wearable portion and coupled with the at least one eddy current probe via the connector, the operator interface including:
an indexing area configured to indicate a status of the at least one eddy current probe with respect to the article; and
an operator interface display configured to display information relating to a status of the at least one eddy current probe.

2. The wearable inspection device of claim 1, wherein the wearable inspection device includes a strap coupled with the operator interface.

3. The wearable inspection device of claim 1, wherein the wearable inspection device is a glove.

4. The wearable inspection device of claim 2, wherein the at least one eddy current probe is amongst a plurality of probes, the at least one eddy current probe disposed at along or at a distal end of a digit region of the glove.

5. The wearable inspection device of claim 1, wherein the wearable inspection device further comprises an additional eddy current probe such that the wearable device includes an array of eddy current probes.

6. The wearable inspection device of claim 1, wherein the operator interface comprises:
a voice receiver circuit configured to receive voice commands from the user, the receiver circuit communicatively coupled to a control circuit such that, in response to a voice command received from a user, the control circuit is configured to at least one of activate article inspection or deactivate article inspection.

7. The wearable inspection device of claim 1, wherein the monitoring panel is configured to wirelessly communicate with a remote computing device.

8. The wearable inspection device of claim 1, wherein the probe status indicator provides an indicium to a user indicative of a lift-off condition of the eddy current probe.

9. The wearable inspection device of claim 8, wherein the operator interface includes the probe status indicator and the indicium is a light configured to illuminate based on a distance between the at least one eddy current probe and the article.

10. A system for inspecting an article, the system comprising:
a wearable portion comprising:
at least one eddy current probe at the wearable portion;
an operator interface coupled with the wearable portion and coupled with the at least one eddy current probe via the connector, the operator interface including:
an indexing area configured to indicate a status of the at least one eddy current probe with respect to the article; and
an operator interface display configured to display information relating to a status of the at least one eddy current probe;
a compartment, the compartment comprising:
an analysis device coupled with one of the at least one eddy current probe and the operator interface, wherein the at least one eddy current probe is configured to transmit data to the analysis device; and
a power source, the power source being coupled with the at least one eddy current probe.

11. The system of claim 10, wherein the at least one eddy current probe is amongst a plurality of probes, the at least one eddy current probe disposed at along or at a distal end of a digit region of a glove.

12. The system of claim 11, wherein respective probes amongst the plurality of probes are located along or at respective distal ends of respective digit regions.

13. The system of any of claim 11, wherein the at least one eddy current probe is an eddy current array (ECA) flexible probe.

14. The system of any of claim 11, wherein the wearable inspection device further comprises an additional eddy current probe such that the wearable device includes an array of eddy current probes.

15. The system of any of claim 11, wherein the monitoring panel comprises:
a voice receiver circuit configured to receive voice commands from the user, the receiver circuit communicatively coupled to a control circuit such that, in response to a voice command received from a user, the controller is configured to at least one of activate article inspection or deactivate article inspection.

16. The system of claim 10, wherein the monitoring panel is configured to wirelessly communicate with another analysis device.

17. The system of claim 10, wherein the analysis device is wirelessly communicatively coupled with the wearable inspection device.

18. The system of claim 10, wherein the analysis device is communicatively coupled with the wearable inspection device with a wired interface.

19. The system of claim 18, wherein the wired interface comprises a detachable interconnect.

20. The system of claim 10, wherein the system further comprises a transceiver communicatively coupled with the analysis device such that the analysis device and the transceiver form a gateway configured to communicate with a remote server.
